(19) United States
(12) Patent Application Publication
(10) Pub. No.: US 2015/0113551 A1
(43) Pub. Date: Apr. 23, 2015

(54) COMPUTING SYSTEM WITH CONTENT DELIVERY MECHANISM AND METHOD OF OPERATION THEREOF

(71) Applicant: Samsung Electronics Co., Ltd., Gyeonggi-Do (KR)

(72) Inventor: James Roy Carl Hicks, San Jose, CA (US)

(73) Assignee: Samsung Electronics Co., Ltd., Gyeonggi-Do (KR)

(21) Appl. No.: 14/061,706

(22) Filed: Oct. 23, 2013

(51) Int. Cl. H04N 21/442; G05B 15/02

(52) U.S. Cl. CPC H04N 21/44218; G05B 15/02
USPC 725/10; 700/90

(57) ABSTRACT

A computing system includes: a control unit configured to: capture an activity indicator representing a sound indicator, a movement indicator, or a combination thereof, determine a cheer indicator based on filtering the activity indicator according to a sound type, a movement type, or a combination thereof, determine a support cheer level based on aggregating a plurality of the cheer indicator, and a user interface, coupled to the control unit, configured to present the support cheer level.

### TECHNICAL FIELD

An embodiment of the present invention relates generally to a computing system, and more particularly to a system for content delivery mechanism.

### BACKGROUND

Modern consumer and industrial electronics, such as computing systems, televisions, projectors, cellular phones, portable digital assistants, and combination devices, are providing increasing levels of functionality to support modern life. In addition to the explosion of functionality and proliferation of these devices into the everyday life, there is also an explosion of data and information being created, transported, consumed, and stored.

The explosion of data and information comes in different types, e.g. text, sounds, images, as well as for different domains/applications, e.g. social networks, electronic mail, web searches, and different formats, e.g. structure, unstructured, or semi-structured. Research and development for handling this dynamic mass of data and information in existing technologies can take a myriad of different directions. However, the inability by the modern consumer to share data and information effectively decreases the benefit of using the tool.

Thus, a need still remains for a computing system with content delivery mechanism for effectively addressing the mass of data and information and consumer's inability across various domains. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### SUMMARY

An embodiment of the present invention provides a computing system, including: a control unit configured to: capture an activity indicator representing a sound indicator, a movement indicator, or a combination thereof, determine a cheer indicator based on filtering the activity indicator according to a sound type, a movement type, or a combination thereof, determine a support cheer level based on aggregating a plurality of the cheer indicator, and a user interface, coupled to the control unit, configured to present the support cheer level.

An embodiment of the present invention provides a method of operation of a computing system including: capturing an activity indicator representing a sound indicator, a movement indicator, or a combination thereof; determining a cheer indicator based on filtering the activity indicator according to a sound type, a movement type, or a combination thereof; and determining a support cheer level with a control unit based on aggregating a plurality of the cheer indicator for presenting on a device.

An embodiment of the present invention provides a non-transitory computer readable medium including: capturing an activity indicator representing a sound indicator, a movement indicator, or a combination thereof; determining a cheer indicator based on filtering the activity indicator according to a sound type, a movement type, or a combination thereof; and determining a support cheer level based on aggregating a plurality of the cheer indicator for presenting on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with content delivery mechanism in an embodiment of the present invention.

FIG. 2 is an example of an engagement context.

FIG. 3 is an example of a target content presented by the first device.

FIG. 4 is an exemplary block diagram of the computing system.

FIG. 5 is a control flow of the computing system.

### DETAILED DESCRIPTION

An embodiment of the present invention provides a method and system configured to determine a support cheer level to be shared amongst a plurality of a user. The embodiment of the present invention can display, as an example, an average support level for a cheer indicator expressed as a sound indicator, a movement indicator, or a combination thereof by the plurality of user. As a result, the embodiment of the present invention can provide an engagement context amongst the plurality of the user to share the experience, for example, expressing emotion for the same entity, such as a sports team.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

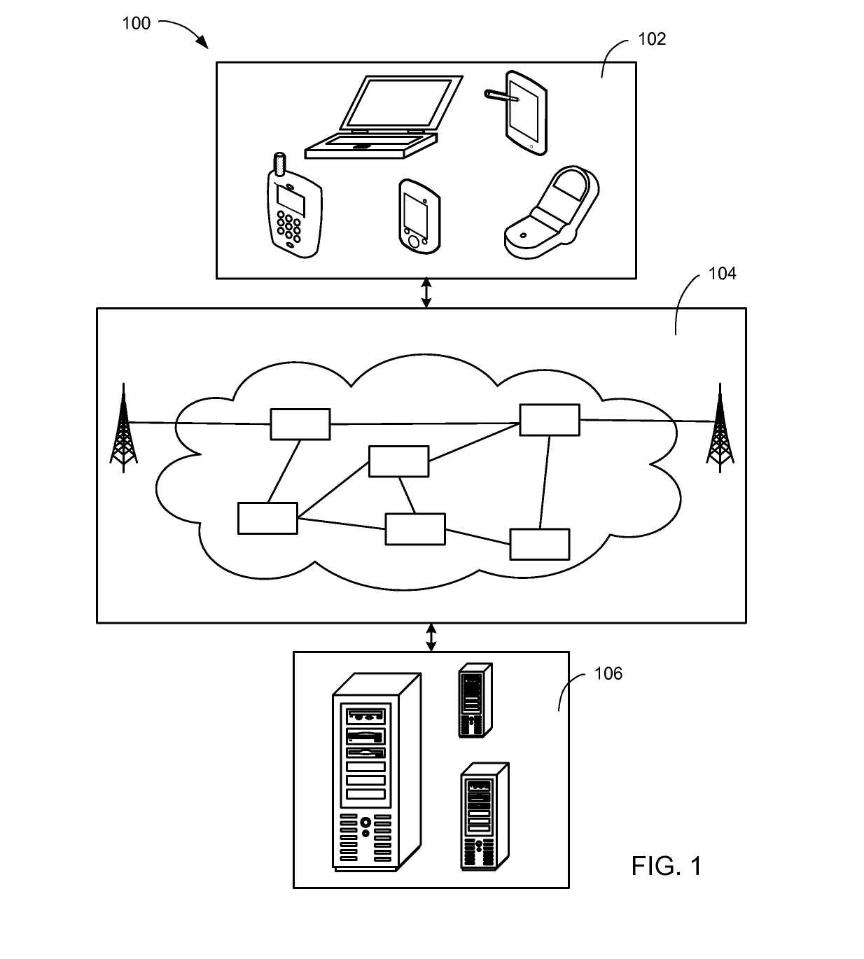

Referring now to FIG. 1, therein is shown a computing system 100 with content delivery mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, wearable digital device, tablet, notebook computer, television (TV), automotive telematic communication system, or other multi-functional mobile communication or entertainment device. The first device 102 can be a standalone device, or can be incorporated with a vehicle, for example a car, truck, bus, aircraft, boat/vessel, or train. The first device 102 can couple to the communication path 104 to communicate with the second device 106.

For illustrative purposes, the computing system 100 is described with the first device 102 as a display device, although it is understood that the first device 102 can be different types of devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Android™ smartphone, or Windows™ platform smartphone.

For illustrative purposes, the computing system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, aircraft, boat/vessel, or train.

Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, wireless High-Definition Multimedia Interface (HDMI), Near Field Communication (NFC), Infrared Data Association standard (IrDA), wireless fidelity (WiFi), and worldwide interoperability for microwave access (WiMAX) are examples of wireless communication that can be included in the communication path 104. Ethernet, HDMI, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

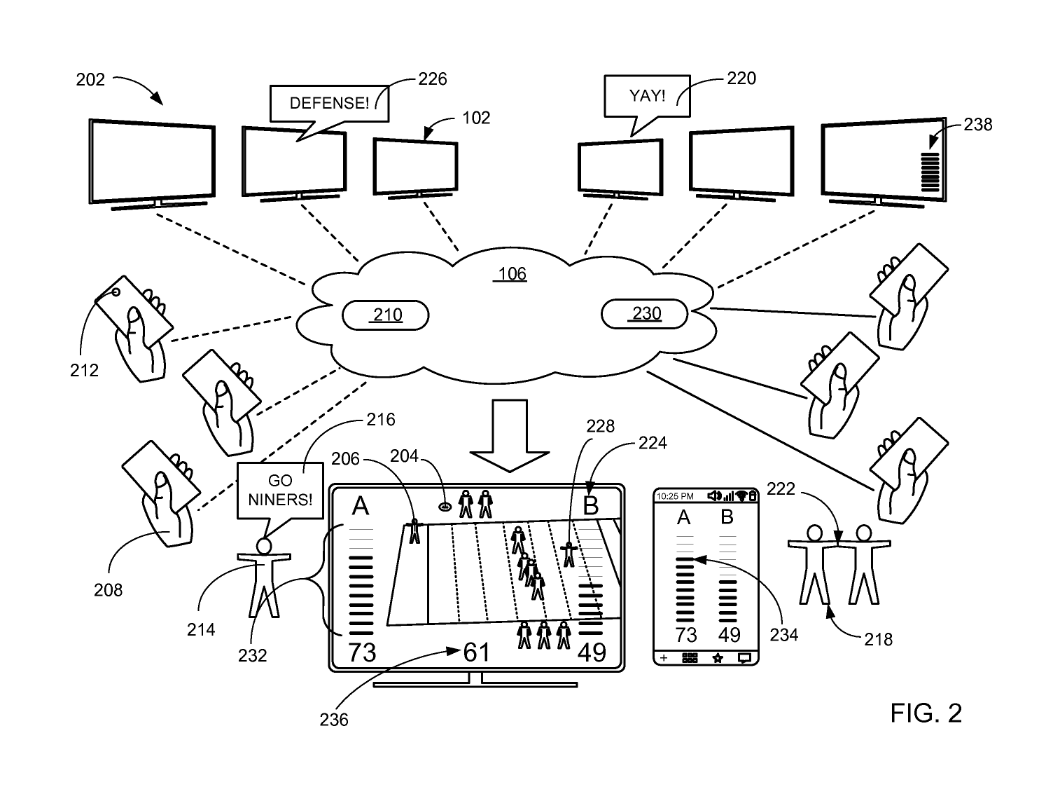

Referring now to FIG. 2, therein is shown an example of an engagement context 202. The engagement context 202 is a situation, circumstance, or a combination thereof surrounding the first device 102. For clarity and brevity, the discussion of an embodiment of the present invention will focus on the first device 102 displaying the result generated by the computing system 100 of FIG. 1. However, the second device 106 and the first device 102 can be discussed interchangeably.

The engagement context 202 can be determined based on an event type 204, an event situation 206, a current location 208, a user profile 210, or a combination thereof. The event type 204 is a category of activity accessed from the first device 102. For example, the event type 204 can represent a sports game broadcasted by a network television on the first device 102 representing a TV. The event situation 206 is a state of condition occurring in the event type 204. For example, the event situation 206 can represent a condition that can exist at a particular time in a particular place. For a specific example, the event situation 206 can represent San Francisco 49ers™, an American football team, scoring a touchdown in the fourth quarter with 2 minutes left in the game.

The current location 208 is a physical location of the first device 102. For example, the current location 208 can represent that the user of the first device 102 is at home. The user profile 210 is personal information. For example, the user profile 210 can represent the personal information of the user of the computing system 100. The user can enter the team that the user would like to root for in the first device 102 as part of the user profile 210.

The first device 102 can include a capturing sensor 212. The capturing sensor 212 is a device incorporated with the first device 102 to capture the engagement context 202. For example, the capturing sensor 212 can capture an activity indicator 214 occurring within the engagement context 202. The activity indicator 214 is information regarding an activity occurring in the engagement context 202. For example, the activity indicator 214 can represent a sound indicator 216, a movement indicator 218, or a combination thereof.

The sound indicator 216 is an auditory information occurring in the engagement context 202. For example, the sound indicator 216 can represent a shout by the user of the computing system 100 for responding to the event situation 206. The movement indicator 218 is an information related to a physical act occurring in the engagement context 202. For example, the movement indicator 218 can represent clapping, high flying, or a combination thereof occurring in the engagement context 202. A sound type 220 is a categorization of the sound indicator 216. A movement type 222 is a categorization of the movement type 222.

The computing system 100 can determine a cheer indicator 224 based on the activity indicator 214. The cheer indicator 224 is information regarding an activity occurring in response to the event type 204, the event situation 206, or a combination thereof. For example, the cheer indicator 224 can represent the shouting by the user of the computing system 100 in response to the event situation 206 of 49ers™ playing defense against the opponent.

A cheer pattern 226 is an arrangement of the cheer indicator 224. For example, the cheer pattern 226 can represent an arrangement of the cheer indicator 224 under a particular instance of the event situation 206. For example, the cheer pattern 226 can represent the cheer indicator 224 representing the sound indicator 216 of shouting “defense!” when the event situation 206 represents the user's team is playing defense.

A cheer target 228 is an object of the cheer indicator 224. For example, the cheer target 228 can represent the user's favorite sports team, a player on the team, or a combination thereof. A viewer profile 230 is information regarding an audience viewing the event type 204, the event situation 206, or a combination thereof.

A support cheer level 232 is an intensity level of the cheer indicator 224. As an example, the support cheer level 232 can be measured based on decibel. The support cheer level 232 can include a peak cheer level 234, an average cheer level 236, or a combination thereof. The peak cheer level 234 is highest intensity level of the cheer indicator 224. For example, the peak cheer level 234 can represent the highest intensity amongst a plurality of the cheer indicator 224. The average cheer level 236 is an average intensity level of the cheer indicator 224. For example, the average cheer level 236 can represent an average intensity of a plurality of the cheer indicator 224. A device volume 238 is a magnitude of the sound coming out from the first device 102.

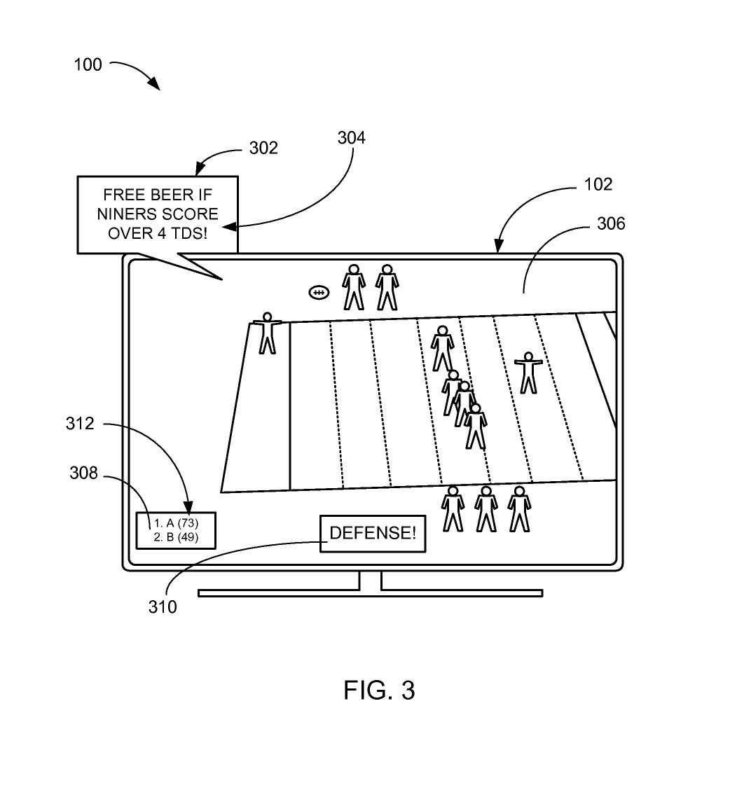

Referring now to FIG. 3, therein is shown an example of a target content 302 presented by the first device 102. The target content 302 is information presented on the first device 102 in response to determining the support cheer level 232 of FIG. 2. For example, the target content 302 can include a target notification 304, an event highlight 306, a cheer ranking 308, a chant notification 310, a cheer score 312, or a combination thereof. For further example, the target content 302 can include the support cheer level 232 to be displayed on the first device 102.

The target notification 304 can represent an advertisement. The event highlight 306 is a summary of the event type 204 of FIG. 2, the event situation 206 of FIG. 2, or a combination thereof. The cheer ranking 308 is an order of the cheer indicator 224 of FIG. 2. For example, the cheer ranking 308 can represent the order of the cheer indicator 224 based on a plurality of the peak cheer level 234 of FIG. 2. The cheer score 312 can represent a point assigned for the support cheer level 232. For example, the cheer score 312 can range from a value of 0 to 1, 0 to 100, or a combination thereof. The chant notification 310 is an information presented by the first device 102 to entice an organized chant. For example, the chant notification 310 can represent the target content 302 to entice a plurality of the user of the computing system 100 to shout “defense!” for the event situation 206.

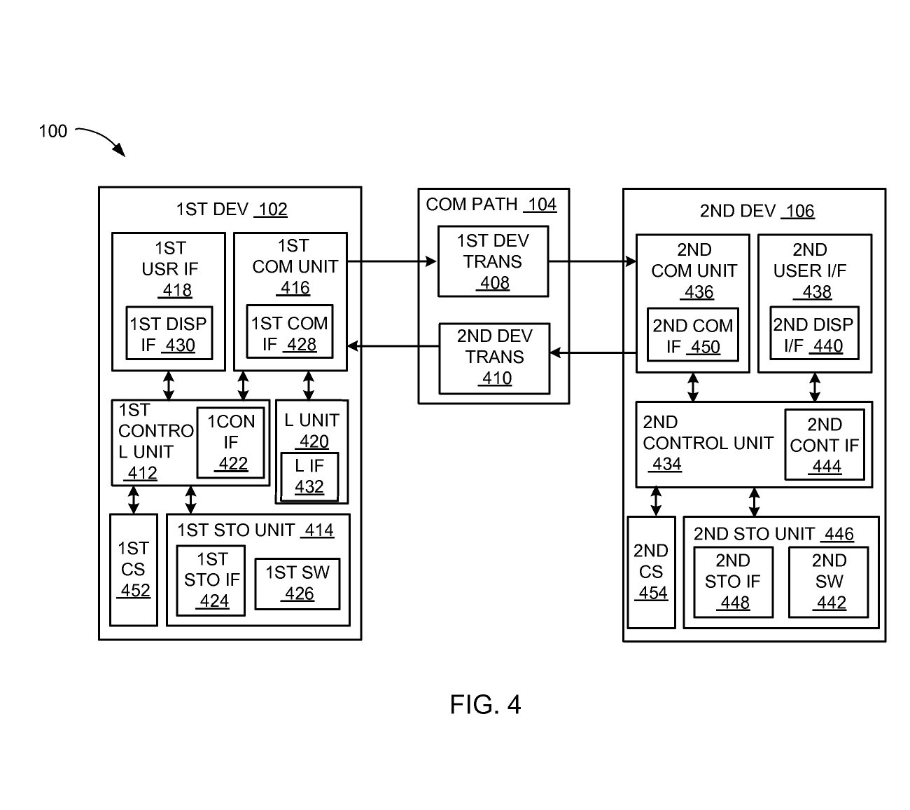

Referring now to FIG. 4, therein is shown an exemplary block diagram of the computing system 100. The computing system 100 can include the first device 102, the communication path 104, and the second device 106. The first device 102 can send information in a first device transmission 408 over the communication path 104 to the second device 106. The second device 106 can send information in a second device transmission 410 over the communication path 104 to the first device 102.

For illustrative purposes, the computing system 100 is shown with the first device 102 as a client device, although it is understood that the computing system 100 can have the first device 102 as a different type of device. For example, the first device 102 can be a server.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. An embodiment of the present invention is not limited to this selection for the type of devices. The selection is an example of an embodiment of the present invention.

The first device 102 can include a first control unit 412, a first storage unit 414, a first communication unit 416, a first user interface 418, and a location unit 420. The first control unit 412 can include a first control interface 422. The first control unit 412 can execute a first software 426 to provide the intelligence of the computing system 100. The first control unit 412 can be implemented in a number of different manners. For example, the first control unit 412 can be a processor, an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations physically separate from the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The location unit 420 can generate location information, current heading, and current speed of the first device 102, as examples. The location unit 420 can be implemented in many ways. For example, the location unit 420 can function as at least a part of a global positioning system (GPS), an inertial computing system, a cellular-tower location system, a pressure location system, or any combination thereof.

The location unit 420 can include a location interface 432. The location interface 432 can be used for communication between the location unit 420 and other functional units in the first device 102. The location interface 432 can also be used for communication that is external to the first device 102.

The location interface 432 can receive information from the other functional units or from external sources, or can transmit information to the other functional units or to external destinations. The external sources and the external destinations refer to sources and destinations physically separate from the first device 102.

The location interface 432 can include different implementations depending on which functional units or external units are being interfaced with the location unit 420. The location interface 432 can be implemented with technologies and techniques similar to the implementation of the first control interface 422.

The first storage unit 414 can store the first software 426. The first storage unit 414 can also store the relevant information, such as advertisements, points of interest (POI), navigation routing entries, or any combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the location unit 420 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations physically separate from the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106, an attachment, such as a peripheral device or a computer desktop, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, a camera, or any combination thereof to provide data and communication inputs.

The first user interface 418 can include a first display interface 430. The first display interface 430 can include a display, a projector, a video screen, a speaker, a headset, or any combination thereof.

The first control unit 412 can operate the first user interface 418 to display information generated by the computing system 100. The first control unit 412 can also execute the first software 426 for the other functions of the computing system 100, including receiving location information from the location unit 420. The first control unit 412 can further execute the first software 426 for interaction with the communication path 104 via the first communication unit 416.

The second device 106 can be optimized for implementing an embodiment of the present invention in a multiple device embodiment with the first device 102. The second device 106 can provide the additional or higher performance processing power compared to the first device 102. The second device 106 can include a second control unit 434, a second communication unit 436, and a second user interface 438.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, a camera, or any combination thereof to provide data and communication inputs. Examples of the output device of the second user interface 438 can include a second display interface 440. The second display interface 440 can include a display, a projector, a video screen, a speaker, a headset, or any combination thereof.

The second control unit 434 can execute a second software 442 to provide the intelligence of the second device 106 of the computing system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the computing system 100, including operating the second communication unit 436 to communicate with the first device 102 over the communication path 104.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations physically separate from the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the computing system 100 is shown with the second storage unit 446 as a single hierarchy storage system, although it is understood that the computing system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the location unit 420 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations physically separate from the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The computing system 100 can be executed by the first control unit 412, the second control unit 434, or a combination thereof.

A first capturing sensor 452 can represent the capturing senor 212 of FIG. 2. For example, the first capturing sensor 452 can capture the sound indicator 216 of FIG. 2, the movement indicator 218 of FIG. 2, or a combination thereof.

Examples of the first capturing sensor 452 can include a digital camera, video camera, thermal camera, night vision camera, infrared camera, x-ray camera, or the combination thereof. Examples of the first capturing sensor 452 can include accelerometer, thermometer, microphone, wireless signal receiver, remote physiological monitoring device, light identifier, or the combination thereof.

A second capturing sensor 454 can represent the capturing senor 212. For example, the second capturing sensor 454 can capture the sound indicator 216, the movement indicator 218, or a combination thereof.

Examples of the second capturing sensor 454 can include a digital camera, video camera, thermal camera, night vision camera, infrared camera, x-ray camera, or the combination thereof. Examples of the second capturing sensor 454 can include accelerometer, thermometer, microphone, wireless signal receiver, remote physiological monitoring device, light identifier, or the combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100. For example, the first device 102 is described to operate the location unit 420, although it is understood that the second device 106 can also operate the location unit 420.

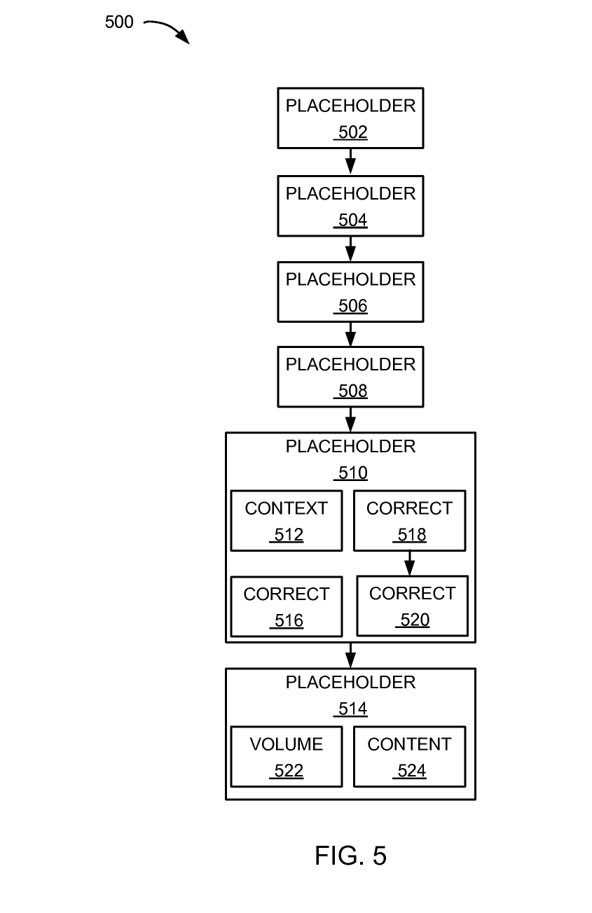

Referring now to FIG. 5, therein is shown a control flow 500 of the computing system 100. The computing system 100 can include a context module 502. The context module 502 determines the engagement context 202 of FIG. 2. For example, the context module 502 can determine the engagement context 202 based on the event type 204 of FIG. 2, the current location 208 of FIG. 2, the event situation 206 of FIG. 2, the user profile 210 of FIG. 2, or a combination thereof.

For a specific example, the current location 208 can represent that user is in the living room of the user's home. Moreover, the first device 102 can represent a television. The event type 204 can represent a televised sports game, such as American football game, displayed on the first device 102 of FIG. 1 representing a television. The user profile 210 can disclose that the user is a fan of 49ers™. The event situation 206 can represent that the 49ers™ is losing by 1 point with 1 minute left. Based on the event type 204, the current location 208, the event situation 206, the user profile 210, or a combination thereof, the context module 502 can determine the engagement context 202 as user is viewing the 49er game at home with great anticipation for the 49er to come back and win.

More specifically, the context module 502 can communicate with external sources to obtain the event type 204, the event situation 206, or a combination thereof via the first control interface 422 of FIG. 4. For example, the context module 502 can obtain the event type 204, the event situation 206, or a combination thereof from external sources, such as television network, website, or a combination thereof. The context module 502 can determine the current location 208 with the location unit 420 of FIG. 4. The user profile 210 can be stored within the first storage unit 414 of FIG. 4 of the first device 102. The context module 502 can communicate the engagement context 202 to a capture module 504.

The computing system 100 can include the capture module 504, which can couple to the context module 502. The capture module 504 captures the activity indicator 214 of FIG. 2. For example, the capture module 504 can capture the sound indicator 216 of FIG. 2, the movement indicator 218 of FIG. 2, or a combination thereof with the capturing sensor 212 of FIG. 2.

The capture module 504 can capture the activity indicator 214 in a number of ways. For example, the capture module 504 can capture the sound indicator 216 based on measuring the decibel within the engagement context 202. For another example, the capture module 504 can capture the movement indicator 218 by recording the user's movement within the engagement context 202. The capture module 504 can communicate the activity indicator 214 to a determinator module 506.

The computing system 100 can include the determinator module 506, which can couple to the capture module 504. The determinator module 506 determines the cheer indicator 224 of FIG. 2. For example, the determinator module 506 can determine the cheer indicator 224 based on the activity indicator 214.

The determinator module 506 can determine the cheer indicator 224 in a number of ways. For example, the determinator module 506 can determine the cheer indicator 224 based on the activity indicator 214, the user profile 210, the engagement context 202, or a combination thereof. More specifically, the determinator module 506 can determine the cheer indicator 224 based on filtering the activity indicator 214 according to the sound type 220 of FIG. 2, the movement type 222 of FIG. 2, or a combination thereof.

For a specific example, the determinator module 506 can determine the sound indicator 216 based on filtering for the sound type 220. The first storage unit 414 can store a variety of the sound type 220 categorized according to the engagement context 202. For example, the sound type 220 representing cheer, exultant shout, glee, roar, or a combination thereof can be categorized under the event type 204 of sports games. For another example, the sound type 220 representing bawl, sob, or a combination thereof can be categorized under melodrama movie.

For another example, the determinator module 506 can determine the movement indicator 218 based on filtering for the movement type 222. The first storage unit 414 can store a variety of the movement type 222 categorized according to the engagement context 202. For example, the movement type 222 representing first pump, dancing, jumping, high flying, or a combination thereof can be categorized under the event type 204 of sports games. For another example, the movement type 222 representing tearing, stillness, or a combination thereof can be categorized under melodrama movie.

As discussed previously, the engagement context 202 can represent the user viewing the 49er game at home with great anticipation for the 49er to come back and win. The determinator module 506 can determine the cheer indicator 224 by comparing the sound type 220 of the sound indicator 216 captured to the sound type 220 of the sound indicator 216 stored in the first storage unit 414. More specifically, the determinator module 506 can determine the cheer indicator 224 to represent the sound type 220 of cheer based on the engagement context 202 determined.

For another example, the determinator module 506 can determine the cheer indicator 224 by comparing the movement type 222 of the movement indicator 218 captured to the movement type 222 of the movement indicator 218 stored in the first storage unit 414. More specifically, the determinator module 506 can determine the cheer indicator 224 to represent the movement type 222 of cheer based on the engagement context 202 determined. The determinator module 506 can communicate the cheer indicator 224 to the context module 502, a pattern module 508, or a combination thereof.

The computing system 100 can include the pattern module 508, which can couple to the determinator module 506. The pattern module 508 generates the cheer pattern 226 of FIG. 2. For example, the pattern module 508 can generate the cheer pattern 226 based on the cheer indicator 224, the user profile 210, the engagement context 202, or a combination thereof.

The pattern module 508 can generate the cheer pattern 226 in a number of ways. For example, the pattern module 508 can generate the cheer pattern 226 based on tracking the cheer indicator 224. Continuing with the example discussed above, the cheer indicator 224 can represent that the user is supporting the 49ers™. Furthermore, the pattern module 508 can track the cheer indicator 224 for a particular instance of the engagement context 202 to generate the cheer pattern 226.

For example, the pattern module 508 can track the cheer indicator 224 representing a chant for “Defense!” when the event situation 206 represents the 49ers™ is playing defense. For another example, the pattern module 508 can track the cheer indicator 224 representing the sound indicator 216 “Touchdown!” and the movement indicator 218 of high flying when the event situation 206 represents the 49ers™ scores a touchdown. Based on the cheer indicator 224 for the event situation 206, the pattern module 508 can generate the cheer pattern 226 representative of the engagement context 202.

For another example, the pattern module 508 can generate the cheer pattern 226 based on tracking the cheer indicator 224 for the event type 204. For example, the event type 204 can represent the 49ers™ game. The cheer indicator 224 can represent a chant for “Let's go Niners!” for the 49ers™ game. For a different example, the event type 204 can represent a game for the San Francisco Giants™, an American baseball team. The cheer indicator can represent a chant for “Let's go Giants!” for the Giants™ game. As a result, the pattern module 508 can generate the cheer pattern 226 representative of the event type 204.

For another example, the pattern module 508 can generate the cheer pattern 226 based on the user profile 210. More specifically, the cheer indicator 224 from the user who is male or female can different under the same instance of the engagement context 202. For example, the cheer indicator 224 for the female can include the movement indicator 218 of a hug when the 49ers™ score a touchdown while the male can include the movement indicator 218 of a high five without the hug. For further example, the cheer indicator 224 for the female can include the sound indicator 216 of a screech while the sound indicator 216 for the male can represent a roar. Based on the user profile 210, the pattern module 508 can generate the cheer pattern 226 for the engagement context 202. The pattern module 508 can communicate the cheer pattern 226 to the context module 502, an aggregator module 510, or a combination thereof.

For illustrative purposes, the computing system 100 is described with the context module 502 determining the engagement context 202 based on the event type 204, the current location 208, the event situation 206, the user profile 210, or a combination thereof, although it is understood that the context module 502 can operate differently. For example, the context module 502 can determine the engagement context 202 based on the cheer indicator 224.

For a specific example, the context module 502 can determine the engagement context 202 by determining the cheer target 228 of FIG. 2, the viewer profile 230 of FIG. 2, the event situation 206, or a combination thereof based on the cheer indicator 224. More specifically, the context module 502 can determine the cheer target 228 based on the cheer indicator 224 displayed by the user when the user's favored sports team is doing well. The context module 502 can determine the cheer target 228 to be, for example, the 49ers™.

For further example, the cheer indicator 224 can include the name of the player and the words used for the player, team, or a combination thereof. Based on the content of the cheer indicator 224, the context module 502 can determine the cheer target 228 of who or which team the user is rooting for.

For another example, the context module 502 can determine the viewer profile 230 based on the cheer indicator 224. The user profile 210 may not include the user's favorite team. However, based on the cheer indicator 224, the context module 502 can determine the cheer target 228 as discussed above. As a result, the context module 502 can determine the viewer profile 230 that represents which team the user is rooting for. The context module 502 can update the user profile 210 based on the viewer profile 230 determined.

For another example, the context module 502 can determine the event situation 206 based on the cheer indicator 224. More specifically, the context module 502 can determine the event situation 206 without communicating with the external sources. For example, based on the cheer indicator 224, the context module 502 can determine the event situation 206 of whether the user's team is winning or losing.

For further example, the context module 502 can determine the engagement context 202 based on the cheer pattern 226 of the cheer indicator 224. The cheer pattern 226 can include of the movement indicator 218 of high flying along with the sound indicator 216 of cheer of “Touchdown!” The context module 502 can determine the engagement context 202 of something positive had occurred for the American football team supported by the user. The context module 502 can communicate the engagement context 202 to the aggregator module 510.

It has been discovered that the computing system 100 can determine the engagement context 202 based on the cheer indicator 224 for improving the efficiency of operating the first device 102, the computing system 100, or a combination thereof. By analyzing the cheer indicator 224, the computing system 100 can determine the cheer target 228, the viewer profile 230, the cheer pattern 226, or a combination thereof without conscious user input into the computing system 100. As a result, the computing system 100 can determine the engagement context 202 without conscious user input for improved efficiency of operating the first device 102, the computing system 100, or a combination thereof.

The computing system 100 can include the aggregator module 510, which can couple to the pattern module 508, the context module 502, or a combination thereof. The aggregator module 510 determines the support cheer level 232 of FIG. 2. For example, the aggregator module 510 can determine the support cheer level 232 based on aggregating a plurality of the cheer indicator 224.

The aggregator module 510 can determine the support cheer level 232 in a number of ways. For example, the aggregator module 510 can determine the support cheer level 232 based on collecting the plurality of the cheer indicator 224 from each instances of the first device 102 from a plurality of the user.

The aggregator module 510 can include a peak module 512. The peak module 512 determines the support cheer level 232 representing the peak cheer level 234 of FIG. 2. For example, the peak module 512 can determine the peak cheer level 234 based on the engagement context 202, the cheer pattern 226, or a combination thereof.

The peak module 512 can determine the peak cheer level 234 in a number of ways. For example, the peak module 512 can determine the peak cheer level 234 for the engagement context 202 representing the entirety of the event type 204, such as the sports game. For another example, the peak module 512 can determine the peak cheer level 234 for the event situation 206. As an example, the peak module 512 can determine the peak cheer level 234 for the event situation 206 when the 49ers™ are playing offense or defense.

For further example, the peak module 512 can determine the peak cheer level 234 based on determining the highest decibel of the cheer indicator 224 representing the sound indicator 216 for the engagement context 202. Moreover, the peak module 512 can determine the peak cheer level 234 at a specific timestamp for the engagement context 202 to determine when the peak cheer level 234 was recorded.

For a different example, the peak module 512 can determine the peak cheer level 234 based on the cheer pattern 226 having the movement indicator 218 for the engagement context 202. More specifically, the cheer pattern 226 can represent the motion of giving high five when the 49ers™ scores a touchdown. The peak module 512 can determine the peak cheer level 234 based on rapidity of a plurality of viewers giving high fives when the 49ers™ scores. The peak cheer level 234 can represent the highest number of high fives within a set time span. The peak module 512 can communicate the peak cheer level 234 to an output module 514.

The aggregator module 510 can include an average module 516. The average module 516 calculates the support cheer level 232 representing the average cheer level 236 of FIG. 2. For example, the average module 516 can calculate the average cheer level 236 based on averaging the cheer indicator 224 representing the sound indicator 216. More specifically, the average module 516 can calculate the average cheer level 236 based on averaging the decibel of the sound indicator 216. Furthermore, the average module 516 can calculate the average cheer level 236 for the engagement context 202 in its entirety, the event type 204, the event situation 206, or a combination thereof. The average module 516 can communicate the output module 514.

The aggregator module 510 can include a score module 518. The score module 518 calculates the cheer score 312 of FIG. 3. For example, the score module 518 can calculate the cheer score 312 based on a plurality of the cheer indicator 224. More specifically, the cheer indicator 224 can represent the sound indicator 216. The score module 518 can calculate the cheer score 312 based on the decibel of the sound indicator 216 provided by the user. The cheer score 312 can represent the decibel or a number ranging from 0 to 1 or 0 to 100. The score module 518 can communicate the cheer score 312 to a rank module 520.

The aggregator module 510 can include the rank module 520, which can couple to the score module 518. The rank module 520 generates the cheer ranking 308 of FIG. 3 based on ranking a plurality of the cheer score 312. As discussed above, the cheer score 312 can be calculated for each users of the computing system 100. For example, the rank module 520 can generate the cheer ranking 308 based ranking the plurality of the cheer score 312 from highest to the lowest. For further example, the rank module 520 can generate the cheer ranking 308 based on ranking the plurality of the cheer score 312 for the engagement context 202 in its entirety, the event type 204, the event situation 206, or a combination thereof. The rank module 520 can communicate the cheer ranking 308 to the output module 514.

The computing system 100 can include the output module 514, which can couple to the aggregator module 510. The output module 514 determines the device volume 238 of FIG. 2, generates the target content 302 of FIG. 3, or a combination thereof. For example, the output module 514 can determine the device volume 238 based on the support cheer level 232, the engagement context 202, or a combination thereof. For another example, the output module 514 can determine the target content 302 based on the event highlight 306 of FIG. 3.

The output module 514 can include a volume module 522. The volume module 522 determines the device volume 238. For example, the volume module 522 can determine the device volume 238 based on the support cheer level 232, the engagement context 202, or a combination thereof.

The volume module 522 can determine the device volume 238 in a number of ways. For example, the volume module 522 can determine the device volume 238 of the first device 102 based on the support cheer level 232, the engagement context 202, or a combination thereof. More specifically, the volume module 522 can increase the device volume 238 if the support cheer level 232 of the cheer indicator 224 exceeds the average cheer level 236.

For further example, the volume module 522 can change the device volume 238 based on the engagement context 202. For a specific example, the event situation 206 can represent halftime for the sports game. The volume module 522 can decrease the device volume 238 of the first device 102 based on the fact that the sports game is at halftime. For another example, the event situation 206 can represent the event situation 206 of the 49ers™ scoring a touchdown. Based on the support cheer level 232 of the cheer indicator 224 meeting or exceeding the average cheer level 236, the volume module 522 can increase the device volume 238.

The output module 514 can include a content module 524. The content module 524 generates the target content 302. For example, the content module 524 can generate the target content 302 based on the support cheer level 232, the event highlight 306, or a combination thereof.

The content module 524 can generate the target content 302 in a number of ways. For example, the support cheer level 232 can represent the peak cheer level 234. The content module 524 can generate the target content 302, such the target notification 304 of FIG. 3, based on the event highlight 306 of the event situation 206 that recorded the peak cheer level 234. For another example, the content module 524 can generate the target content 302 having the average cheer level 236 for presenting on the first device 102.

For another example, the content module 524 can generate the target content 302 representing the chant notification 310 of FIG. 3. More specifically, the content module 524 can generate the chant notification 310 for organizing a plurality of the user of the computing system 100 to perform the sound indicator 216 representing a chant. For a specific example, the event type 204 can represent a sports game for the University of California, Los Angeles (UCLA). The content module 524 can generate the chant notification 310 to organize the plurality of the user to perform the sound indicator 216 representing the “eight clap,” a chant to support UCLA. The output module 514 can present the support cheer level 232, the target content 302, or a combination thereof on the first device 102.

The physical transformation from determining the support cheer level 232 results in the movement in the movement in the physical world, such as people using the first device 102, the computing system 100, or a combination thereof. As the movement in the physical world occurs, the movement itself creates additional information that is converted back into determining the engagement context 202, the support cheer level 232, the device volume 238, the target content 302, or a combination thereof for the continued operation of the computing system 100 and to continue movement in the physical world.

The first software 426 of FIG. 4 of the first device 102 of FIG. 4 can include the computing system 100. For example, the first software 426 can include the context module 502, the capture module 504, the determinator module 506, pattern module 508, the aggregator module 510, and the output module 514.

The first control unit 412 of FIG. 4 can execute the first software 426 for the context module 502 to determine the engagement context 202. The first control unit 412 can execute the first software 426 for the capture module 504 to capture the activity indicator 214. The first control unit 412 can execute the first software 426 for the determinator module 506 to determine the cheer indicator 224. The first control unit 412 can execute the first software 426 for the pattern module 508 to generate the cheer pattern 226. The first control unit 412 can execute the first software 426 for the aggregator module 510 to determine the support cheer level 232. The first control unit 412 can execute the first software 426 for the output module 514 to determine the device volume 238, to generate the target content 302, or a combination thereof.

The second software 442 of FIG. 4 of the second device 106 of FIG. 4 can include the computing system 100. For example, the second software 442 can include the context module 502, the capture module 504, the determinator module 506, pattern module 508, the aggregator module 510, and the output module 514.

The second control unit 434 of FIG. 4 can execute the second software 442 for the context module 502 to determine the engagement context 202. The second control unit 434 can execute the second software 442 for the capture module 504 to capture the activity indicator 214. The second control unit 434 can execute the second software 442 for the determinator module 506 to determine the cheer indicator 224. The second control unit 434 can execute the second software 442 for the pattern module 508 to generate the cheer pattern 226. The second control unit 434 can execute the second software 442 for the aggregator module 510 to determine the support cheer level 232. The second control unit 434 can execute the second software 442 for the output module 514 to determine the device volume 238, to generate the target content 302, or a combination thereof.

The computing system 100 can be partitioned between the first software 426 and the second software 442. For example, the second software 442 can include the context module 502, the capture module 504, the determinator module 506, pattern module 508, and the aggregator module 510. The second control unit 434 can execute modules partitioned on the second software 442 as previously described.

The first software 426 can include the output module 514. Based on the size of the first storage unit 414, the first software 426 can include additional modules of the computing system 100. The first control unit 412 can execute the modules partitioned on the first software 426 as previously described.

The first control unit 412 can operate the first communication unit 416 of FIG. 4 to communicate the activity indicator 214, the support cheer level 232, the target content 302, or a combination thereof to or from the second device 106. The first control unit 412 can operate the first software 426 to operate the location unit 420. The second communication unit 436 of FIG. 4 can communicate the activity indicator 214, the support cheer level 232, the target content 302, or a combination thereof to or from the first device 102 through the communication path 104 of FIG. 4.

The first control unit 412 can operate the first user interface 418 to display the support cheer level 232, the target content 302, or a combination thereof. The second control unit 434 can operate the second user interface 438 of FIG. 4 to display the support cheer level 232, the target content 302, or a combination thereof.

The computing system 100 describes the module functions or order as an example. The modules can be partitioned differently. For example, the context module 502 and the capture module 504 can be combined. Each of the modules can operate individually and independently of the other modules. Furthermore, data generated in one module can be used by another module without being directly coupled to each other. For example, the aggregator module 510 can receive the engagement context 202 from the context module 502.

The modules described in this application can be hardware circuitry, hardware implementation, or hardware accelerators in the first control unit 412 or in the second control unit 434. The modules can also be hardware circuitry, hardware implementation, or hardware accelerators within the first device 102 or the second device 106, but outside of the first control unit 412 or the second control unit 434, respectively as depicted in FIG. 4. However, it is understood that the first control unit 412, the second control unit 434, or a combination thereof can collectively refer to all hardware accelerators for the modules.

The modules described in this application can be implemented as instructions stored on a non-transitory computer readable medium to be executed by a first control unit 412, the second control unit 434, or a combination thereof. The non-transitory computer medium can include the first storage unit 414, the second storage unit 446 of FIG. 4, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

The control flow 500 or the method 500 of operation of the computing system 100 includes: capturing an activity indicator representing a sound indicator, a movement indicator, or a combination thereof; determining a cheer indicator based on filtering the activity indicator according to a sound type, a movement type, or a combination thereof; and determining a support cheer level with a control unit based on aggregating a plurality of the cheer indicator for presenting on a device.

It has been discovered that the computing system 100 can capture the activity indicator 214 representing the sound indicator 216, the movement indicator 218, or a combination thereof for improving the efficiency and user experience of operating the computing system 100. By capturing the activity indicator 214, the computing system 100 can determine the cheer indicator 224 by filtering the activity indicator 214 according to the sound type 220, the movement type 222, or a combination thereof. As a result, the computing system 100 can determine the support cheer level 232 for presenting the support cheer level 232 to a plurality of the first device 102 engaged in the event type 204, the event situation 206, or a combination thereof. Therefore, a plurality of the user of the computing system 100 can share the experience amongst the users for improved efficiency and the user experience for operating the first device 102, the computing system 100, or a combination thereof.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance. These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a control unit configured to:
capture an activity indicator representing a sound indicator, a movement indicator, or a combination thereof,
determine a cheer indicator based on filtering the activity indicator according to a sound type, a movement type, or a combination thereof,
determine a support cheer level based on aggregating a plurality of the cheer indicator, and
a user interface, coupled to the control unit, configured to present the support cheer level.

2. The system as claimed in claim 1 wherein the control unit is configured to calculate an average cheer level based on averaging the plurality of the cheer indicator.

3. The system as claimed in claim 1 wherein the control unit is configured to determine a peak cheer level based on determining an instance of the cheer indicator highest amongst the plurality of the cheer indicator.

4. The system as claimed in claim 1 wherein the control unit is configured to generate a cheer pattern based on tracking the cheer indicator within an engagement context.

5. The system as claimed in claim 1 wherein the control unit is configured to determine an engagement context by determining a cheer target, a viewer profile, or a combination thereof for updating a user profile.

6. The system as claimed in claim 1 wherein the control unit is configured to determine a device volume based on the support cheer level meeting or exceeding an average cheer level.

7. The system as claimed in claim 1 wherein the control unit is configured to generate a target content based on an event situation with a peak cheer level.

8. The system as claimed in claim 1 wherein the control unit is configured to determine the precision level based on comparing the entry to an entry baseline.

9. The system as claimed in claim 1 wherein the control unit is configured to:
calculate a cheer score for the plurality of the cheer indicator; and
generating a cheer ranking based on ranking the plurality of the cheer indicator according to the cheer score.

10. The system as claimed in claim 1 wherein the control unit is configured to generate a chant notification for organizing a plurality of the sound indicator, the movement indicator, or a combination thereof.

11. A method of operation of a computing system comprising:
capturing an activity indicator representing a sound indicator, a movement indicator, or a combination thereof;
determining a cheer indicator based on filtering the activity indicator according to a sound type, a movement type, or a combination thereof; and
determining a support cheer level with a control unit based on aggregating a plurality of the cheer indicator for presenting on a device.

12. The method as claimed in claim 11 wherein determining the support cheer level includes calculating an average cheer level based on averaging the plurality of the cheer indicator.

13. The method as claimed in claim 11 wherein determining the support cheer level includes determining a peak cheer level based on determining an instance of the cheer indicator highest amongst the plurality of the cheer indicator.

14. The method as claimed in claim 11 further comprising generating a cheer pattern based on tracking the cheer indicator within an engagement context.

15. The method as claimed in claim 11 further comprising determining an engagement context by determining a cheer target, a viewer profile, or a combination thereof for updating a user profile.

16. A non-transitory computer readable medium comprising:
capturing an activity indicator representing a sound indicator, a movement indicator, or a combination thereof;
determining a cheer indicator based on filtering the activity indicator according to a sound type, a movement type, or a combination thereof; and
determining a support cheer level based on aggregating a plurality of the cheer indicator for presenting on a device.

17. The non-transitory computer readable medium as claimed in claim 16 wherein determining the support cheer level includes calculating an average cheer level based on averaging the plurality of the cheer indicator.

18. The non-transitory computer readable medium as claimed in claim 16 wherein determining the support cheer level includes determining a peak cheer level based on determining an instance of the cheer indicator highest amongst the plurality of the cheer indicator.

19. The non-transitory computer readable medium as claimed in claim 16 further comprising generating a cheer pattern based on tracking the cheer indicator within an engagement context.

20. The non-transitory computer readable medium as claimed in claim 16 further comprising determining an engagement context by determining a cheer target, a viewer profile, or a combination thereof for updating a user profile.
